(19) United States
(12) Patent Application Publication
(10) Pub. No.: US 2020/0166427 A1
(43) Pub. Date: May 28, 2020

(54) SUBSEA VALVE, FLOW SYSTEM AND METHOD OF USE

(71) Applicant: EnerMech Limited, Aberdeen (GB)

(72) Inventors: Stephen Barron, Aberdeen (GB); Allan Martin, Aberdeen (GB)

(21) Appl. No.: 16/779,002

(22) Filed: Jan. 31, 2020

Related U.S. Application Data
(63) Continuation of application No. 15/523,644, filed on May 1, 2017, now abandoned.

(30) Foreign Application Priority Data
Oct. 30, 2014 (GB) 1419320.5

(51) Int. Cl. G01M 3/00; E21B 43/01; F16K 15/02; E21B 41/00; G01M 3/02; F16L 55/46; F16L 1/12; F04D 29/22; F04D 15/00; F04D 13/08; F04D 13/06

(52) U.S. Cl. CPC G01M 3/005; E21B 43/01; F16K 15/025; E21B 41/0007; G01M 3/02; F16L 55/46; F16L 2101/30; F16K 15/026; F04D 29/22; F04D 15/0005; F04D 13/08; F04D 13/066; F16L 1/12

(57) ABSTRACT

The invention provides a flow system, a subsea valve, and a method of use in a subsea pipeline filling, flooding or pigging operation. The flow system comprises a subsea valve comprising a valve inlet and a valve outlet configured to be coupled to a subsea pipeline. A pump comprises a pump inlet connected to a fluid source and a pump outlet connected to the valve inlet. The pump is operable to pump fluid from the fluid source and into the subsea pipeline via the subsea valve. The subsea valve comprises a movable valve member and a biasing mechanism, by which the valve member is urged by a biasing force towards a closed position that prevents flow of fluid through the valve and into the subsea pipeline. The valve member is operable to be moved to an open position on activation of the pump to provide a pressure increase at the valve inlet sufficient to overcome the biasing force. In use, opposing sides of the valve member are exposed to ambient subsea pressure such that the subsea valve is pressure balanced.

The present invention relates to a subsea valve, a flow system and a method of use, and in particular to subsea valve, a flow system and method of use in a pipeline filling, flooding or pigging application. Aspects of the invention relate to a subsea apparatus including a valve, a flow system including the subsea apparatus, and a method of use.

### BACKGROUND TO THE INVENTION

In the field of subsea engineering, it is common to lay pipelines on the seabed in a sealed condition and full of air or gas at atmospheric pressure. After the pipeline is laid, it may be flooded with seawater and may subsequently be pressure tested to ensure that there are no fluid leaks in the pipeline.

A number of subsea contractors provide systems which use combinations of hydrostatic pressure and/or a topsides or subsea booster pump for filling, flooding or pigging the pipeline, or increasing the pressure in the pipeline.

In shallow water applications, it is generally preferred to use a topsides pump connected to the subsea pipeline by a downline. The pump is used to deliver fluid to flood or fill the pipeline and optionally a pipeline pig may be driven along the pipeline by the fluid flow. When flooding or pigging subsea pipelines or flowlines that have been laid sealed and full of air at atmospheric pressure, the flooding equipment, when connected, has to be protected from the effects of differential pressure due to hydrostatic head. The differential pressure will have the tendency to cause excessive flow to pass through the pump and tends to collapse equipment and connections to the pipeline once the pipeline valve is opened for flooding and pigging.

FIG. 1 shows schematically another flow system which is commonly used in the subsea industry in pipeline filling, flooding and pigging operations. The system 10 comprises a topside or subsea pump 12 for pumping fluid into the pipeline 13, and a check valve 14 (known as a Surplussing Valve) disposed between the pipeline 13 and the pump 12. The check valve functions to prevent unwanted flow of seawater into the pipeline through the pump due to the hydrostatic head, which would tend to collapse equipment and connections to the pipeline. The valve has a failsafe closed position, and a spring 15 keeps the valve closed against the differential pressure between the hydrostatic head and the initial low pressure in the pipeline 13. When the pump is operated, an excess pressure forces the valve open and enables flow into the pipeline.

Although the flow system of FIG. 1 prevents uncontrolled flow of fluids through the pump and into the pipeline, it is necessary to set the check valve to withstand the hydrostatic pressure at the depth at which the equipment is to be operated. Different depths of operation require the valve to be reset. Furthermore, the pressure differentials to be held by the valve may be very large, particularly for deepwater applications, which results in large, bulky and heavy valve configurations which are expensive to manufacture and may be difficult to transport and deploy. Moreover, as the pressure in the pipeline gets closer to and is eventually equalised with the hydrostatic pressure, the contribution of the hydrostatic pressure to the opening of the valve is reduced. The opening force must instead be due to the pressure differential created by the booster pump. This necessitates the use of high pressure pumps such as positive displacement pumps or multi-stage centrifugal pumps, particularly in deepwater applications, which may be large, bulky, and weighty and may have high power consumption.

FIG. 2 is a graphical representation of the required pump pressure Pₚ during operation of the flow system of FIG. 1. The valve 14 is set to a cracking pressure Pᵥ, which is greater than the hydrostatic pressure at the depth at which the valve is used. The pump will be required to increase the pressure in the system to be equal to the cracking pressure Pᵥ During the initial part of the filling operation (up to time t₁) the large differential pressure ΔP between the pipeline pressure and the hydrostatic pressure makes a significant contribution to opening the valve 14, and the required pump pressure Pₚ to raise the overall pressure to Pᵥ is relatively modest. However, after time t₁, as the pressure in the pipeline increases, ΔP reduces and the contribution from the pump is greater (i.e. the required pump pressure Pₚ increases). Ultimately Pₚ must equal or exceed Pᵥ when the pressure in the pipeline is equal to hydrostatic pressure (after time t₂) and the pressure differential ΔP is zero.

GB2303895 describes an alternative method in which an initially gas-filled subsea pipeline is opened to enable ambient hydrostatic pressure to act on a pipeline pig. The pressure differential drives the pig through the pipeline to compress the gas, and seawater fills the pipeline behind the pig. The inflow of seawater is regulated to control the pig velocity.

WO02/088658 and WO03/031865 disclose methods in which the hydrostatic head is used to flood the pipeline in an initial operation pigging operation, until the pressure is equalised between the internal pipeline pressure and the ambient seawater pressure. In a second phase of operation, a pump valve is opened to enable a booster pump to increase the pressure to complete the pigging and/or testing operations. The valves are manually operated by a diver or actuated by an ROV.

WO2013/040296 is another example of a subsea apparatus which uses a combination of hydrostatic pressure and a booster pump in a filling, flooding and/or hydrotesting operation. The apparatus uses hydrostatic pressure to pump the pig during an initial flooding phase. In a second phase, a skid mounted pump completes the pigging operation. The apparatus is self-powered, and pressure and/or flow rate sensors provide control signals to an electronic control unit, which in turn actuates an electronically-operated pump valve to enable or prevent flow from the pump to the pipeline.

While the hydrostatic pressure flooding systems proposed in the above-referenced are applicable to a range of pipeline filling, flooding, pigging or testing operations, one limitation of the systems is that they are relatively inflexible in their application. Each system is optimised for operation at a particular depth, with a flow rate (and therefore a pig velocity) which is preconfigured by design or setting of the inflow parameters. If variation to the inflow rate is desired or required immediately prior to or during use, the equipment must be reconfigured at surface (for example by change out of an inflow orifice) or attended by an ROV or diver in a subsea location. Alternatively, a relatively sophisticated valve control subsystem can be included in the subsea equipment, adding to cost and complexity of the equipment.

Furthermore, the flooding or fill rate (and therefore the pig velocity) is dependent on the magnitude of the differential pressure between the pipeline and the hydrostatic head. In very shallow water, the filling rate may be slower than is desirable for a cost-effective flooding, filling or pigging operation. In addition, use of the hydrostatic pressure flooding systems described above results in a changing flow rate, which decreases from an initially high flow rate when the pipeline is first opened, to a lower flow rate as the pressure differential between the pipeline and the hydrostatic head decreases during flooding. This issue is exacerbated in a situation in which a pigging operation requires a pig to be driven from an initially deep pipeline position to a shallow pipeline position.

### SUMMARY OF INVENTION

It is amongst the objects of the invention to provide a subsea valve, a flow system, a subsea apparatus, and/or a method of use as an alternative to the systems proposed in the prior art.

One aim of the invention is to provide a subsea flow system and method of use in a flooding, filling or pigging operation which protects subsea and topside equipment from the effects of excessive flow and a tendency to collapse.

Another aim of the invention is to provide an apparatus and method which enables the use of relatively low pressure pumping and connection equipment in pipeline filling, flooding or pigging operations.

One aim of the invention is to provide subsea flooding apparatus and/or a subsea valve which is relatively lightweight, small, and/or low in bulk compared to prior art subsea flooding apparatus and/or subsea valves.

Another aim of the invention is to provide an apparatus and flow system which is relatively simple to deploy and configure, and/or which is cost-effective and economical to operate.

Another aim of the invention is to provide an apparatus and method of use which provides flooding rate, filling rate and/or pipeline pig velocity which is not dependent on a pressure differential between a pipeline and the hydrostatic head in use.

A further object of an aspect of the invention is to an apparatus and method of use in a pipeline filling, flooding or pigging operation which enables flooding rate, filling rate and/or pipeline pig velocity to be controlled and/or varied throughout all phases of the operation.

Further aims and objects of the invention will be apparent from the following description.

According to a first aspect of the invention, there is provided a flow system for use in a subsea pipeline filling, flooding or pigging operation, the flow system comprising:

a subsea valve comprising a valve inlet and a valve outlet configured to be coupled to a subsea pipeline;
a pump comprising a pump inlet connected to a fluid source and a pump outlet connected to the valve inlet;
wherein the pump is operable to pump fluid from the fluid source and into the subsea pipeline via the subsea valve;
wherein the subsea valve comprises a movable valve member and a biasing mechanism, by which the valve member is urged by a biasing force towards a closed position that prevents flow of fluid through the valve and into the subsea pipeline;
wherein the valve member is operable to be moved to an open position when the pump is activated to provide a pressure increase at the valve inlet that is sufficient to overcome the biasing force;
and wherein in use, opposing sides of the valve member are exposed to ambient subsea pressure such that the subsea valve is pressure balanced.

By providing a flow system with pressure-balanced valve, the pump and connected flow equipment are protected from risk of excessive flow and collapse due to differential pressure, while the operation of the valve is unaffected by hydrostatic pressure. This enables the biasing force to be set independently of hydrostatic pressure, advantageously at a lower magnitude which facilitates use of low pressure pumps to open the valve through all phases of a flooding, filling or pigging operation. The pressure balanced valve also facilitates use of the system at a range of depths without adjustment.

Preferably, the valve outlet is pressure-isolated from subsea ambient pressure when the valve is in a closed position.

In one embodiment, the pump is a subsea pump, which may be connected to the valve inlet via a subsea flow conduit. The subsea pump may be an electrically driven pump, and may be a centrifugal-type pump.

In another embodiment, the pump is a surface or topsides pump, which may be connected to the valve inlet via a downline. The surface or topsides pump may be an electrically driven pump, and may be a centrifugal-type pump.

The flow protection functionality of the flow system enables the subsea flow conduit and/or downline, and indeed other components of the system, to be specified with a standard pressure rating, rather than a high collapse-resistant rating.

Preferably the fluid source is a body of water in which the flow system is to be deployed.

According to a second aspect of the invention, there is provided a subsea valve for use in a subsea pipeline filling, flooding or pigging operation, the subsea valve comprising:

a main housing comprising a valve inlet configured to be coupled to a pump and a valve outlet configured to be coupled to a subsea pipeline;
a valve member movable between a first closed position which prevents flow of fluid through the valve and a second open position; and
a biasing mechanism for transferring a biasing force to the valve member to urge the valve member towards the first closed position;
wherein the valve member is operable to be moved to an open position when exposed to a pressure increase at the valve inlet that is sufficient to overcome the biasing force;
and wherein in use, opposing sides of the valve member are exposed to ambient subsea pressure such that the subsea valve is pressure balanced.

Preferably, the biasing mechanism comprises a spring. Preferably, the biasing mechanism is selected to determine a cracking pressure of the valve, at which the biasing force is overcome to open the valve. Preferably, the cracking pressure is in the range of 10 kPa to 1000 kPa and more preferably is in the range of 25 kPa to 100 kPa.

The valve member may comprise a valve seat on a first side. A chamber may be provided on one side of the valve member, and may be at least partially defined by the main housing. The chamber may be provided on a side of the valve member which opposes the valve seat.

Preferably, in the open position, the valve enables the subsea pipeline to be filled or flooded by fluid passing through the valve.

Preferably, in the closed position, the valve member prevents flow of fluid through the valve and into the subsea pipeline.

Preferably the valve is configured to be coupled to the pipeline in a fixed position relative to the pipeline.

Preferably the valve member comprises a seal, which may be located between opposing sides of the valve member. The seal may isolate the valve inlet and the valve outlet from the chamber. Preferably the chamber is exposed to subsea ambient pressure.

Preferably, the valve member comprises a piston block movable in the main housing of the valve. The valve member may comprise a first piston face exposed to pressure at the valve inlet. The valve member may comprise a second piston face exposed to pressure in the chamber. Preferably, the biasing mechanism acts on the second piston face of the valve member.

Preferably, the valve outlet is pressure-isolated from subsea ambient pressure when the valve is in a closed position.

The chamber preferably comprises a subsea pressure sensing port.

The main housing may be substantially cylindrical and may define a substantially cylindrical longitudinal throughbore extending from the first end of the housing to a second end of the housing. The throughbore may be open at the lower end of the housing to define the valve inlet. The valve outlet may be substantially perpendicular (or radial) to the throughbore.

The housing may accommodate a sleeve, and the valve member may be configured to move in the sleeve.

The main housing and/or the sleeve may be profiled to provide an increased inner diameter portion which surrounds the sleeve and defines an annular space between the sleeve and the main housing.

The main housing may be profiled on its inner surface to provide an increased inner diameter portion which surrounds the sleeve and defines an annular space between the sleeve and the housing. The sleeve may be provided with a number of radial apertures which are arranged to provide fluid communication between the internal volume of the sleeve and the annular space or the valve outlet.

Embodiments of the second aspect of the invention may include one or more features of the first aspect of the invention or its embodiments, or vice versa.

According to a third aspect of the invention, there is provided a method of filling, flooding or pigging a pipeline, the method comprising:

providing a flow system comprising:
a subsea valve comprising a valve inlet and a valve outlet configured to be coupled to a subsea pipeline, the subsea valve further comprising a movable valve member and a biasing mechanism, by which the valve member is urged by a biasing force towards a closed position that prevents flow of fluid through the valve and into the subsea pipeline;
a pump comprising pump inlet connected to a fluid source and a pump outlet connected to the valve inlet;
   exposing opposing sides of the movable valve member to ambient subsea pressure such that the subsea valve is pressure balanced;
   operating the pump to increase pressure at the valve inlet sufficiently to overcome the biasing force on the valve member and move the valve member to an open position; and
   pumping fluid from the fluid source and into the subsea pipeline via the subsea valve to fill, flood, or pig the pipeline.

The method may comprise driving the pump from an electrical power source.

The pump may be a subsea pump, or may be a topsides pump.

The method may comprise controlling the fill rate of the pipeline throughout the filling, flooding or pigging operation. The method may comprise controlling the fill rate of the pipeline by controlling the pumping rate. The method may comprise varying the fill rate of the pipeline by controlling the pumping rate.

Embodiments of the third aspect of the invention may include one or more features of the first or second aspects of the invention or their embodiments, or vice versa.

According to a further aspect of the invention there is provided a flow system for use in a subsea pipeline filling, flooding or pigging operation substantially as described herein with reference to FIG. 4 of the drawings.

According to a further aspect of the invention there is provided a subsea valve for use in a subsea pipeline filling, flooding or pigging operation substantially as described herein with reference to FIG. 3 of the drawings.

According to a further aspect of the invention there is provided a method of filling, flooding or pigging a pipeline substantially as described herein with reference to FIG. 3, 4 or 5 of the drawings.

### BRIEF DESCRIPTION OF THE DRAWINGS

There will now be described, by way of example only, various embodiments of the invention with reference to the following drawings, of which:

FIG. 1 is a schematic representation of a flow system commonly used in the subsea industry in pipeline filling, flooding and pigging operations;

FIG. 2 is a graphical representation of pump pressure during use of the system of FIG. in a pipeline filling operation:

FIG. 3 is a sectional view through a subsea valve according to an embodiment of the invention;

FIG. 4 is a schematic representation of a flow system incorporating the subsea valve of FIG. 3 in accordance with an embodiment of the invention; and

FIG. 5 is a graphical representation of a pump pressure during operation of the flow system of FIG. 4.

### DETAILED DESCRIPTION OF THE PREFERRED EMBODIMENTS

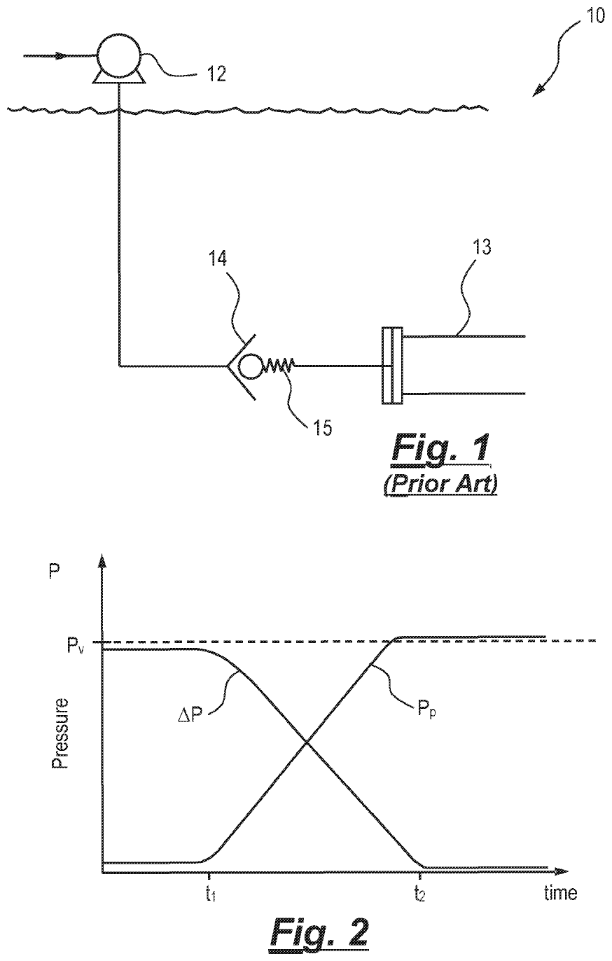

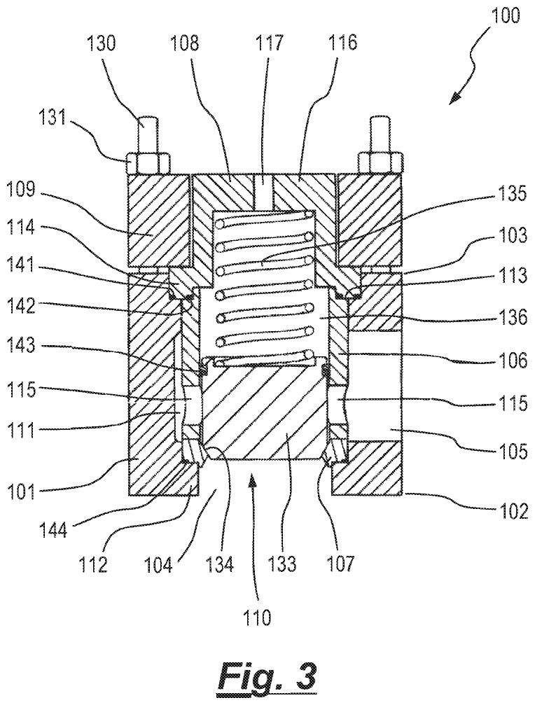

As noted above, FIG. 1 is a schematic representation of a flow system which is commonly used in the subsea industry in pipeline filling, flooding and pigging operations, and FIG. 2 is a graphical representation of pump pressure during use of the flow system in filling a pipeline. FIGS. 1 and 2 are useful for understanding the invention, an embodiment of which will now be described with reference to FIGS. 3 to 5.

The terms “upper”, “lower”, “above”, “below”, “up” and “down” may be used herein to indicate relative positions of the equipment. The invention also has applications in equipment used in orientations other than those shown in the drawings, and when these terms are applied to such orientations they may indicate “left”, “right” or other relative positions in the context of the orientation of the equipment.

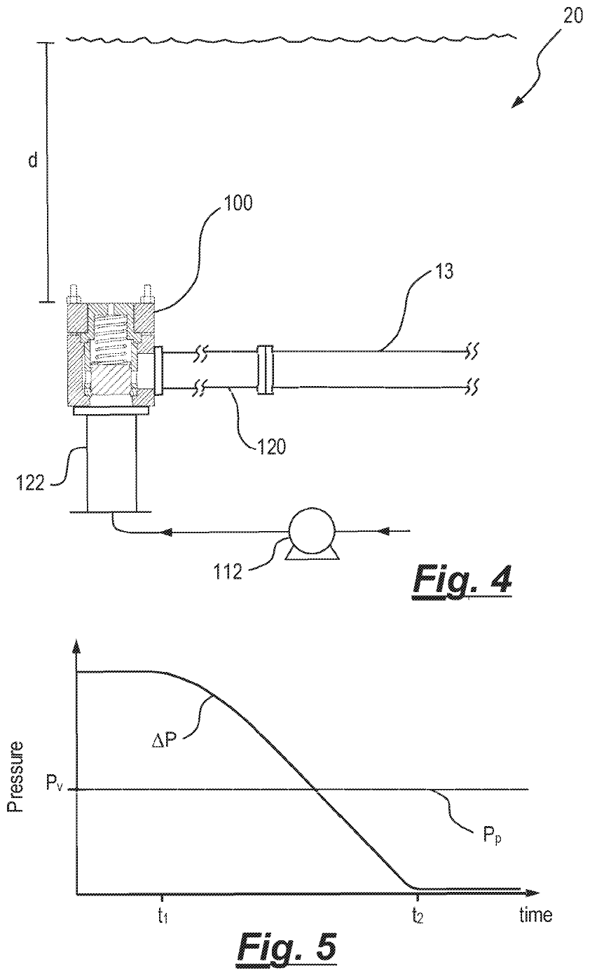

Referring firstly to FIG. 3, there is shown a subsea valve generally depicted at 100, according to a first embodiment of the invention. FIG. 4 shows the valve 100 in a subsea flow system 200. The valve 100 a main housing 101 having a first end 102 and a second end 103, a fluid inlet 104 and a fluid outlet 105. The main housing 101 accommodates the functional components of the valve. These include a sleeve 106 and a movable valve member 133 located within the sleeve and disposed between the inlet 104 and the outlet 105. A locking ring 109 secures the sleeve 106 in the housing between a cap 108 and a ring which defines a valve seat 107. The valve member 133 is biased towards a closed position by a compression spring 135. A leak tight seal is made between valve member 133 and the valve seat 107 to prevent fluid leaking into outlet 105

In this embodiment, the main housing 101 is substantially cylindrical and defines a substantially cylindrical longitudinal throughbore 110 extending from the first end 102 of the housing to a second end 103 of the housing. The housing 101 has a primary inner diameter portion sized and shaped to accommodate the sleeve 106. A lip 112 defines a reduced inner diameter portion at the inlet 104, and provides a shoulder for supporting the valve seat 107. An outer surface of the retaining ring is sealed against the main housing by an elastomeric O-ring seal 144.

The throughbore 110 is open at the lower end 102 of the housing to define the inlet 104. The inlet 104 provides a connection interface (not shown) for a flow conduit 122 to a pump 112, which in this embodiment is a subsea pump.

The outlet 105 of the valve is substantially perpendicular (or radial) to the throughbore 110 in the main housing, and provides a connection interface (not shown) for a flow conduit 120 to a subsea pipeline 13.

The main housing 101 is profiled on its inner surface (e.g. by machining) to provide an increased inner diameter portion which surrounds the sleeve 106 and defines an annular space 111 between the sleeve and the housing.

The sleeve 106, which is also substantially cylindrical, has a longitudinal throughbore, co-axial with the main housing throughbore 110. The sleeve 106 is provided with a number of radial apertures 115 which are arranged around the sleeve to provide fluid communication between the internal volume of the sleeve 106 and the annular space 111 or the outlet 105. In FIG. 3, two such radial apertures 115 are shown, but a greater or lesser number of radial apertures may be provided in alternative embodiments.

At their upper ends, the main housing 101 and sleeve 106 are provided with corresponding stepped ends to create a recess 113 for receiving a ring portion 114 of the cap 108. The lower surface ring portion 114 provides an abutment surface which bears down on the main housing 101 and the sleeve 106. Elastomeric O-ring seals 141, 142 seal the cap against the housing 101 and the sleeve 106. An upper portion 116 of the cap comprises a blind bore which is open to the throughbore of the main housing. Together, the blind bore and the internal volume of the sleeve 106 define a valve chamber 136 between the cap 108 and the moveable valve member 133. An inner surface of the cap 108 provides an abutment surface for the biasing spring 135. The cap is provided with a port 117 which provides fluid communication between the surrounding ambient seawater and the valve chamber 136.

In this embodiment, the valve member 133 is a floating piston block which is sized and shaped to move within the sleeve 106. An upper end of the valve member is sealed against the inner wall of the sleeve by an elastomeric O-ring seal 143. A lower end of the valve member co-operates with the retaining ring 107 to close the valve under the force of the biasing spring 135. The valve seat 107 defines an inwardly tapered surface 134 such that an inner diameter of the valve seat ring is less than the inner diameter of the housing and the sleeve. The tapered surface provides a seat for a corresponding tapered profile of the valve member 133. The upper surface of the valve member comprises a recess for receiving the compression spring.

The valve 100 may be assembled by sequentially placing the valve seat ring 107 (with its seal 144) and the sleeve 106 within the main housing 101. The valve member 133 and spring are placed inside the sleeve 106, and the cap 108 is placed over the housing and the sleeve with the lower ring 114 in the recess 113. Locking ring 109 is placed over the cap 108, and over securing bolts 130 upstanding from the upper end of the main housing 101. With the valve components assembled, the locking nuts 131 are tightened to compress the ring 109 against the cap, causing it to bear down on the housing and the sleeve, energising the seals 141, 142. The sleeve 106 is also compressed against the valve seat 107 which in turn is sealed against the housing 101.

The valve 100 is relatively lightweight, small, and/or low in bulk compared to prior art subsea flooding apparatus and/or subsea valves. Significantly, the valve 100 is a pressure-balanced valve, the operation of which is not affected by hydrostatic pressure, and is therefore capable of being used in a range of applications at a range of depths without modification. Pressure balancing of the valve is achieved simply and effectively by the arrangement of valve components described above. The valve member 133 is exposed to hydrostatic pressure on both sides: on the inlet side (in communication with the outlet of the pump); and from the chamber 136, which is exposed to hydrostatic pressure via the subsea pressure sensing port 117. The chamber 136 is sealed (via seals 141, 142, and 144) against the outlet 105, and is therefore isolated from the pipeline pressure at all stages of the operation. Consequently, operation of the valve (and its pressure-balanced condition) is unaffected by the pressure differential between the pipeline pressure and the ambient hydrostatic pressure.

Use of the valve 100 in flow system 200 will now be described with reference to FIGS. 3, 4 and 5. The flow system 200 is configured as shown in FIG. 4, with the valve 100 connected to a subsea pump 112 on its inlet side via flow conduit 122, and connected to a subsea pipeline 13 on its outlet side via flow conduit 120.

Before the operation begins, the pipeline pressure is relative low (for example atmospheric pressure) compared to the ambient hydrostatic pressure, and therefore the pressure differential ΔP across the valve is relatively large (of the order of 10 bar or 1000 kPa at 100 m depth). FIG. 5 shows graphically the differential pressure ΔP in the early phase of the operation (i.e. before time t₁). The position of the valve 100 is unaffected by the differential pressure, as the hydrostatic pressure acts on both sides of the valve member 133 as described above. The position of the valve 100 is closed by virtue of the spring 135 biasing the valve member against the seat formed by the retaining ring 107. Seawater is not permitted to flow through the valve and into the pipeline, in spite of the high differential pressure. This prevents excessive flow of seawater through the pump, connections and other flow equipment. Excessive flow may cause the pump equipment to be damaged, and a differential pressure would tend to cause the connections and equipment to collapse.

In contrast, flow is only permitted into the pipeline when the pump generates a positive pressure differential which is sufficient to open the valve 100. When the pump 112 is activated, the pump pressure Pₚ is required to exceed the cracking pressure Pᵥ as determined by the biasing spring. Significantly, as the biasing spring is not required to exceed the pressure differential ΔP, the cracking pressure Pᵥ may be relatively low (of the order of 0.5 bar or 50 kPa). This is a marked difference compared with the cracking pressure of a surplussing valve as described with reference to FIG. 1, which would need to be at least 10 bar or 100 kPa (typically an 11 bar or 110 kPa valve is used in a water depth of 100 m). In the system 200, the pump is therefore only required to operate to a pressure Pᵥ to open the valve. The differential pressure between the pump and connection interior and the pump and connection exterior is zero when no fluid is flow, and is low when fluid is flowing, which reduces the tendency to of the connections and flow conduits to collapse.

As the pipeline is filled and the pressure in the pipeline increases (after time t₁), the pressure differential ΔP begins to drop. The pressure differential ΔP has no bearing on the operation of the valve and therefore the pump continues to operate at pressure Pᵥ throughout the filling operation. Fill rate (and therefore pig velocity where applicable) is controlled throughout the operation, by virtue of the controlled flow through the pump and the valve.

The invention provides a flow system, a subsea valve, and a method of use in a subsea pipeline filling, flooding or pigging operation. The flow system comprises a subsea valve comprising a valve inlet and a valve outlet configured to be coupled to a subsea pipeline. A pump comprises a pump inlet connected to a fluid source and a pump outlet connected to the valve inlet. The pump is operable to pump fluid from the fluid source and into the subsea pipeline via the subsea valve. The subsea valve comprises a movable valve member and a biasing mechanism, by which the valve member is urged by a biasing force towards a closed position that prevents flow of fluid through the valve and into the subsea pipeline. The valve member is operable to be moved to an open position on activation of the pump to provide a pressure increase at the valve inlet sufficient to overcome the biasing force. In use, opposing sides of the valve member are exposed to ambient subsea pressure such that the subsea valve is pressure balanced.

The invention as described herein offers a highly effective alternative to the systems proposed in the prior art in the field of subsea valves for pipeline filling, flooding and pigging operations. Firstly, the invention protects subsea and topside equipment from the effects of excessive flow and a tendency to collapse under the differential pressure.

Secondly, the apparatus and method enables the use of relatively low pressure pumping and connection equipment in pipeline filling, flooding or pigging operations. The use of lower pressure-rated equipment reduces capital and operational costs, and reduces footprint size of the equipment required, which reduces the required vessel size and vessel time on station. The low power requirement facilitates the use of electrically driven equipment with high flow capabilities, which may avoid a requirement for flow control and diffuser systems necessary for existing subsea pumping technologies. Deployment costs of the equipment itself and its associated power umbilicals are also reduced compared with the prior art.

The apparatus and flow system which is relatively simple to deploy and configure. In particular, the valve does not need to be reconfigured for application in different depths, increasing the flexibility of operation.

Another benefit is that the apparatus and method of use provides flooding rate, filling rate and/or pipeline pig velocity which is not dependent on a pressure differential between a pipeline and the hydrostatic head in use, and which is controlled and/or varied throughout all phases of the operation by control of the pump. The apparatus and method may be used in a range of applications, including those in which filling under the pressure of hydrostatic head would be slow or would vary greatly, such as in shallow water and or in situations in which the pipeline is being pigged from deep to shallow.

Variations to the described embodiments are within the scope of the invention. For example, the flow system 200 utilises a subsea pump 112, but in an alternative application the pump may be positioned at surface with a connection made to the subsea valve via a downline. The protection against excessive flow provided by the present invention facilitates use of relatively inexpensive standard-rated hoses, rather than high collapse pressure rated hoses. Other pressure-balanced valve configurations may also be used in alternative embodiments of the invention.

Combinations of features other than those expressly claimed herein may also fall within the intended scope of the invention.

1. A subsea valve for use in a subsea pipeline filling, flooding or pigging operation, the subsea valve comprising:
a main housing comprising a valve inlet configured to be coupled to a pump and a valve outlet configured to be coupled to a subsea pipeline;
a valve member movable between a first closed position which prevents flow of fluid through the valve and a second open position; and
a biasing mechanism for transferring a biasing force to the valve member to urge the valve member towards the first closed position;
wherein the valve member is operable to be moved to an open position when exposed to a pressure increase at the valve inlet that is sufficient to overcome the biasing force;
and wherein in use, opposing sides of the valve member are exposed to ambient subsea pressure such that the subsea valve is pressure balanced.

2. The subsea valve according to claim 1, wherein the biasing mechanism comprises a spring.

3. The subsea valve according to claim 1 or claim 2, wherein the biasing mechanism is selected to determine a cracking pressure of the valve, at which the biasing force is overcome to open the valve.

4. The subsea valve according to claim 3, wherein the cracking pressure is in the range of 10 kPa to 1000 kPa.

5. The subsea valve according to claim 4, wherein the cracking pressure is in the range of 25 kPa to 100 kPa.

6. The subsea valve according to any preceding claim, wherein the valve member comprises a valve seat on a first side, and a chamber provided on an opposing side of the valve member.

7. The subsea valve according to any preceding claim, wherein the valve member comprises a seal located between opposing sides of the valve member.

8. The subsea valve according to claim 7 and claim 6, wherein the seal isolates the valve inlet and the valve outlet from the chamber.

9. The subsea valve according to any of claims 6 to 8, wherein the chamber is exposed to subsea ambient pressure.

10. The subsea valve according to any of claims 6 to 9, wherein the chamber comprises a subsea pressure sensing port.

11. The subsea valve according to any preceding claim, wherein the valve member comprises a piston block movable in the main housing of the valve.

12. The subsea valve according to claim 11, wherein the valve member comprises a first piston face exposed to pressure at the valve inlet, and comprises a second piston face exposed to pressure in the chamber.

13. The subsea valve according to claim 12, wherein the biasing mechanism acts on the second piston face of the valve member.

14. The subsea valve according to any preceding claim, wherein the valve outlet is pressure-isolated from subsea ambient pressure when the valve is in a closed position.

15. The subsea valve according to any preceding claim, wherein the main housing is substantially cylindrical and defines a substantially cylindrical longitudinal throughbore extending from the first end of the housing to a second end of the housing;
wherein the throughbore is open at the lower end of the housing to define the valve inlet; and wherein the valve outlet is substantially perpendicular to the throughbore.

16. The subsea valve according to any preceding claim, wherein the housing accommodates a sleeve, and the valve member may be configured to move in the sleeve;
and wherein the main housing and/or the sleeve are profiled to provide an increased inner diameter portion which surrounds the sleeve and defines an annular space between the sleeve and the main housing.

17. The subsea valve according to claim 16, wherein the sleeve is provided with a number of radial apertures which are arranged to provide fluid communication between the internal volume of the sleeve and the annular space or the valve outlet.

18. A flow system for use in a subsea pipeline filling, flooding or pigging operation, the flow system comprising:
a subsea valve comprising a valve inlet and a valve outlet configured to be coupled to a subsea pipeline;
a pump comprising a pump inlet connected to a fluid source and a pump outlet connected to the valve inlet;
wherein the pump is operable to pump fluid from the fluid source and into the subsea pipeline via the subsea valve;
wherein the subsea valve comprises a movable valve member and a biasing mechanism, by which the valve member is urged by a biasing force towards a closed position that prevents flow of fluid through the valve and into the subsea pipeline;
wherein the valve member is operable to be moved to an open position when the pump is activated to provide a pressure increase at the valve inlet that is sufficient to overcome the biasing force;
and wherein in use, opposing sides of the valve member are exposed to ambient subsea pressure such that the subsea valve is pressure balanced.

19. The flow system according to claim 18, wherein the valve outlet is pressure-isolated from subsea ambient pressure when the valve is in a closed position.

20. The flow system according to claim 18 or claim 19, wherein the pump is a subsea pump connected to the valve inlet via a subsea flow conduit.

21. The flow system according to claim 18 or claim 19, wherein the pump is a surface or topsides pump connected to the valve inlet via a downline.

22. The flow system according to any of claims 18 to 21, wherein the pump is an electrically driven pump.

23. The flow system according to any of claims 18 to 22, wherein the pump is a centrifugal-type pump.

24. The flow system according to any of claims 18 to 23, wherein the subsea valve is the subsea valve according to any of claims 1 to 17.

25. A method of filling, flooding or pigging a pipeline, the method comprising:
providing a flow system comprising:
a subsea valve comprising a valve inlet and a valve outlet configured to be coupled to a subsea pipeline, the subsea valve further comprising a movable valve member and a biasing mechanism, by which the valve member is urged by a biasing force towards a closed position that prevents flow of fluid through the valve and into the subsea pipeline;
a pump comprising pump inlet connected to a fluid source and a pump outlet connected to the valve inlet;
exposing opposing sides of the movable valve member to ambient subsea pressure such that the subsea valve is pressure balanced;
operating the pump to increase pressure at the valve inlet sufficiently to overcome the biasing force on the valve member and move the valve member to an open position; and
pumping fluid from the fluid source and into the subsea pipeline via the subsea valve to fill, flood, or pig the pipeline.

26. The method according to claim 25, comprising driving the pump from an electrical power source.

27. The method according to claim 25 or claim 26, wherein the pump is a subsea pump.

28. The method according to claim 25 or claim 26, wherein the pump is a surface or topsides pump.

29. The method according to any of claims 25 to 28, comprising controlling the fill rate of the pipeline throughout the filling, flooding or pigging operation.

30. The method according to any of claims 25 to 29, comprising controlling the fill rate of the pipeline by controlling the pumping rate.

31. The method according to any of claims 25 to 30, comprising varying the fill rate of the pipeline by controlling the pumping rate.

32. The method according to any of claims 25 to 31, comprising, wherein the subsea valve is the subsea valve according to any of claims 1 to 17.

33. A flow system for use in a subsea pipeline filling, flooding or pigging operation substantially as described herein with reference to FIG. 4 of the drawings.

34. A subsea valve for use in a subsea pipeline filling, flooding or pigging operation substantially as described herein with reference to FIG. 3 of the drawings.

35. A method of filling, flooding or pigging a pipeline substantially as described herein with reference to FIG. 3, 4 or 5 of the drawings.
